(19) United States
(12) Patent Application Publication
(10) Pub. No.: US 2026/0073422 A1
(43) Pub. Date: Mar. 12, 2026

(54) COMMUNICATING ADVERTISING CAMPAIGNS

(71) Applicant: ZEFR, Inc., Los Angeles, CA (US)

(72) Inventor: Ryan Jensen Barker, Hermosa Beach, CA (US)

(21) Appl. No.: 19/394,541

(22) Filed: Nov. 19, 2025

Related U.S. Application Data
(63) Continuation-in-part of application No. 18/652,610, filed on May 1, 2024.
(60) Provisional application No. 63/503,299, filed on May 19, 2023.

(51) Int. Cl. G06Q 30/0242; G06F 21/10

(52) U.S. Cl. CPC G06Q 30/0242; G06F 21/10

(57) ABSTRACT

For communicating advertising campaigns, a method trains a global standards model with global content standards and/or advertising scores. The method trains a plurality of campaign characteristic models on campaign characteristics and/or the advertising scores. The method identifies whether content media violates the global content standards using the global standards model. In response to the content media violating the global content standards, the method adds the identified content media to a block list. The method updates the advertising score for the content media for each of the plurality of advertising campaigns based on the category scores and advertiser preferences for the plurality of advertising campaigns.

### CROSS-REFERENCE TO RELATED APPLICATIONS

This application claims priority to U.S. patent application Ser. No. 18/652,610 entitled “Presented Advertising Campaigns” and filed on May 1, 2024 for Ryan Jensen Barker, which is incorporated herein by reference, which claims priority to U.S. Provisional Patent Application No. 63/503,299 entitled “BLOCKING CONTENT” and filed on May 19, 2023, for Ryan Jensen Barker, which is incorporated herein by reference.

### BACKGROUND INFORMATION

The subject matter disclosed herein relates to communicating advertising campaigns.

### BRIEF DESCRIPTION

A method for communicating advertising campaigns is presented. The method trains a global standards model with global content standards and/or advertising scores. The method trains a plurality of campaign characteristic models on campaign characteristics and/or the advertising scores. The method identifies whether content media violates the global content standards using the global standards model. In response to the content media violating the global content standards, the method adds the identified content media to a block list. The method updates the advertising score for the content media for each of the plurality of advertising campaigns based on the category scores and advertiser preferences for the plurality of advertising campaigns. In response to a request for the content media via a network, the method communicates a given advertising campaign with a given advertising score that exceeds an advertising threshold and is not on the block list with the content media via the network to an electronic device, minimizing traffic on the network.

### BRIEF DESCRIPTION OF DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of an advertising system;

FIG. 2A is a schematic block diagram illustrating one embodiment of training global standards models;

FIG. 2B is a schematic block diagram illustrating one embodiment of training campaign characteristic models;

FIG. 2C is a schematic block diagram illustrating one embodiment of generating block lists;

FIG. 2D is a schematic block diagram illustrating one embodiment of generating category scores;

FIG. 2E is a schematic block diagram illustrating one embodiment of generating advertising scores;

FIG. 3 is a schematic block diagram illustrating one embodiment of advertising data;

FIG. 4A is a schematic block diagram illustrating one embodiment of a computer;

FIG. 4B is a schematic block diagram illustrating one embodiment of a neural network;

FIG. 4C is a schematic block diagram illustrating one embodiment of a computer cluster;

FIG. 5A is a flow chart diagram illustrating one embodiment of training models;

FIG. 5B is a flow chart diagram illustrating one embodiment of generating category scores;

FIG. 5C is a flow chart diagram illustrating one embodiment of model training; and

FIG. 5D is a flow chart diagram illustrating one embodiment of presenting an advertising campaign.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. The term “and/or” indicates embodiments of one or more of the listed elements, with “A and/or B” indicating embodiments of element A alone, element B alone, or elements A and B taken together.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims or may be learned by the practice of embodiments as set forth hereinafter. As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having program code embodied thereon.

The computer readable medium may be a tangible computer readable storage medium storing the program code. The computer readable storage medium may be, for example, but not limited to, an electronic, magnetic, optical, electromagnetic, infrared, holographic, micromechanical, or semiconductor system, apparatus, or device, or any suitable combination of the foregoing.

More specific examples of the computer readable storage medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store program code for use by and/or in connection with an instruction execution system, apparatus, or device.

Program code for carrying out operations for aspects of the present invention may be written in any combination of one or more programming languages, including an object-oriented programming language such as MATLAB, Python, Ruby, R, Java, Java Script, Julia, Smalltalk, C++, C sharp, Lisp, Clojure, PHP or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). The computer program product may be shared, simultaneously serving multiple customers in a flexible, automated fashion.

The schematic flowchart diagrams and/or schematic block diagrams in the Figures illustrate the architecture, functionality, and operation of possible implementations. It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Although various arrow types and line types may be employed in the flowchart and/or block diagrams, they are understood not to limit the scope of the corresponding embodiments. Indeed, some arrows or other connectors may be used to indicate only an exemplary logical flow of the depicted embodiment.

The description of elements in each figure may refer to elements of proceeding figures. Like numbers refer to like elements in all figures, including alternate embodiments of like elements.

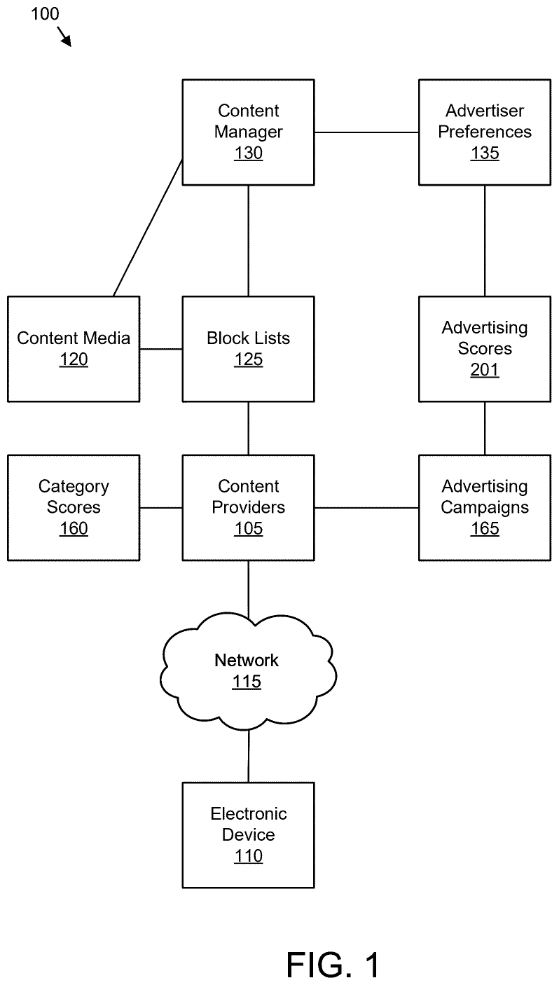

FIG. 1 is a schematic block diagram illustrating one embodiment of an advertising system 100. The advertising system 100 includes a content manager 130, advertising preferences 135, content media 120, block lists 125, advertising scores 201, category scores 160, content providers 105, advertising campaigns 165, a network 115, and an electronic device 110. The advertising preferences 135, content media 120, block lists 125, advertising scores 201, category scores 160, and advertising campaigns 165 may be organized as data structures in one or more memories. The content manager 130 and content providers 105 may comprise data and code executing on one or more computers.

The content media 120 may be managed and provided by one or more content providers 105. For example, the content media 120 may be videos provided by content providers 105 such as YouTube®, TikTok®, and the like. In addition, content media 120 may comprise text, images, audio, video, or combinations thereof.

The electronic device 110 may access the content media 120 via a network 115 such as the Internet, a mobile phone network, and the like. For example, a mobile phone electronic device 110 may access video content media 120. The embodiments prevent presentation of a given advertising campaign 165 with a given content media 120 based on the block list 125. In addition, the embodiments present the given advertising campaign 165 for the content media 120 based on advertising scores 201 and the block list 125.

Advertisers may provide advertising campaigns 165 for presentation with the content media 120. The content manager 130 may manage the advertising campaigns 165 for a plurality of advertisers to prevent associating the advertising campaigns 165 with objectionable content media 120 and present the advertising campaigns 165 with the most commercially advantageous content media 120. The content manager 130 may receive advertiser preferences 135 from each advertiser. The content manager 130 may further generate block lists 125 of content media 120 that will not be presented with advertising campaigns 165.

In addition, the content manager 130 may generate category scores 160 for the content media 120. The content manager 130 may further generate advertising scores 201 for the content media 120 for each advertising campaign 165 based on the category scores 160 and the advertiser preferences 135. The content manager 130 may regularly update the advertising score 201 for content media 120 for each of the advertising campaigns 165 based on impression measurements.

The advertising system 100 may be configured and/or managed by a user and/or by an artificial intelligence (AI) agent. When content media 120 is requested from the content provider 105, the content manager 130 determines whether to present a given advertising campaign 165 for the content media 120 based on the advertising score 201 and the block list 125. As a result, advertising campaigns 165 are not presented with content media 120 that is objectionable to an advertiser and the advertising campaigns 165 are presented with content media 120 that is more advantageous to the advertiser. Therefore, the efficiency and efficacy of the advertising system 100 is improved.

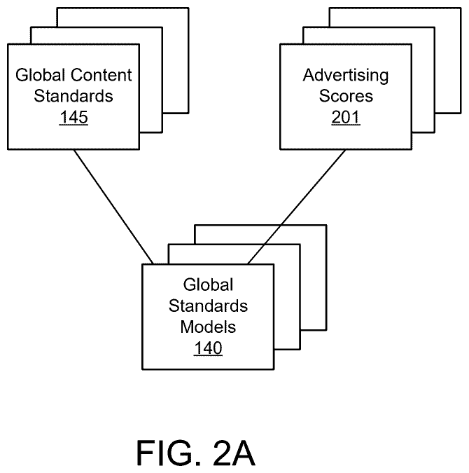

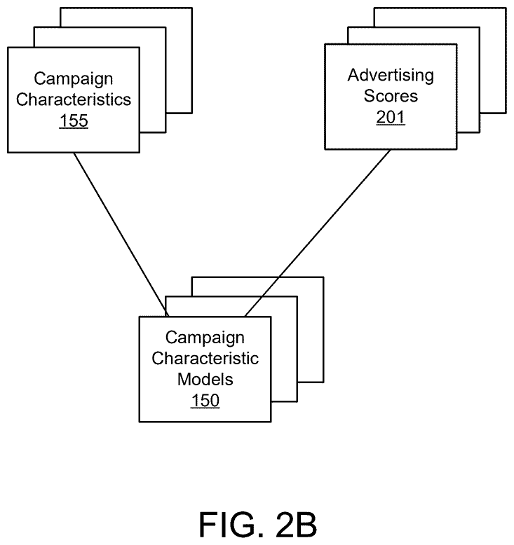

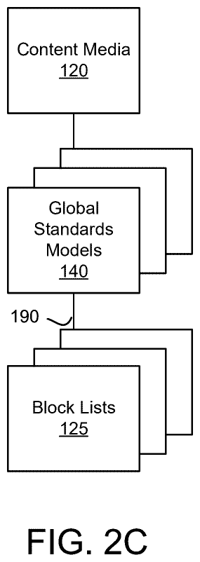

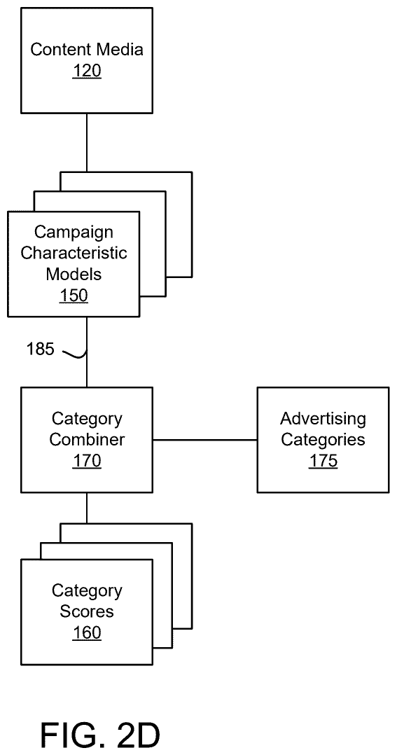

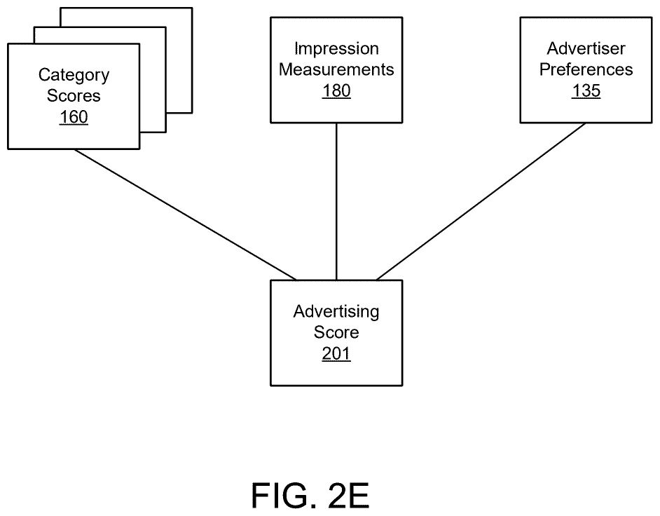

FIG. 2A is a schematic block diagram illustrating one embodiment of training global standards models 140. The global content standards 145, advertising scores 201, and global standards models 140 may be organized as a data structure in a memory. The content manager 130 may employ the global standards models 140 to identify content media 120 for inclusion in block lists 125. In the depicted embodiment, the global standards models 140 are trained on global content standards 145 and/or advertising scores 201.

In one embodiment, each global content standard 145 describes an unacceptable characteristic of content media 120. Examples of unacceptable global content standards 145 may include unacceptable content listed in Table 1 from the Global Alliance for Responsible Media (GARM) document GARM: Brand Safety Floor+Suitability Framework.

TABLE 1

| Category | Unacceptable Content |
|---|---|
| Adult & Explicit Sexual Content | Illegal sale, distribution, and consumption of child |
| | pornography |
| | Explicit or gratuitous depiction of sexual acts, and/or |
| | display of genitals, real or animated |
| Arms & Ammunition | Promotion and advocacy of Sales of illegal arms, |
| | rifles, and handguns |
| | Instructive content on how to obtain, make, |
| | distribute, or use illegal arms |
| | Glamorization of illegal arms for the purpose of harm |
| | to others |
| | Use of illegal arms in unregulated environments |
| Crime & Harmful acts to individuals | Graphic promotion, advocacy, and depiction of willful |
| and Society, Human Right | harm and actual unlawful criminal activity-Explicit |
| Violations | violations/demeaning offenses of Human Rights (e.g. |
| | human trafficking, slavery, self-harm, animal cruelty |
| | etc.), |
| | Harassment or bullying of individuals and groups |
| Death, Injury or Military Conflict | Promotion, incitement or advocacy of violence, death |
| | or injury |
| | Murder or Willful bodily harm to others |
| | Graphic depictions of willful harm to others |
| | Incendiary content provoking, enticing, or evoking |
| | military aggression |
| | Live action footage/photos of military actions & |
| | genocide or other war crimes |
| Online piracy | Pirating, Copyright infringement, & Counterfeiting |
| Hate speech & acts of aggression | Behavior or content that incites hatred, promotes |
| | violence, vilifies, or dehumanizes groups or |
| | individuals based on race, ethnicity, gender, sexual |
| | orientation, gender identity, age, ability, nationality, |
| | religion, caste, victims and survivors of violent acts |
| | and their kin, immigration status, or serious disease |
| | sufferers. |
| Obscenity and Profanity, including | Excessive use of profane language or gestures and |
| language, gestures, and explicitly | other repulsive actions that shock, offend, or insult. |
| gory, graphic or repulsive content | |
| intended to shock and disgust | |
| Illegal Drugs/Tobacco/e- | Promotion or sale of illegal drug use-including abuse |
| cigarettes/Vaping/Alcohol | of prescription drugs. Federal jurisdiction applies, but |
| | allowable where legal local jurisdiction can be |
| | effectively managed |
| | Promotion and advocacy of Tobacco and e-cigarette |
| | (Vaping) & Alcohol use to minors |
| Spam or Harmful Content | Malware/Phishing |
| Terrorism | Promotion and advocacy of graphic terrorist activity |
| | involving defamation, physical and/or emotional |
| | harm of individuals, communities, and society |
| Debated Sensitive Social Issue | Insensitive, irresponsible, and harmful treatment of |
| | debated social issues and related acts that demean a |
| | particular group or incite greater conflict |

In one embodiment, unacceptable global content standards 145 may include high risk unacceptable content listed in Table 2 from the GARM document GARM: Brand Safety Floor. Suitability Framework.

TABLE 2

| Category | Unacceptable Content |
|---|---|
| Adult & Explicit Sexual | Suggestive sexual situations requiring adult |
| Content | supervision/approval or warnings |
| | Full or liberal Nudity |
| Arms & Ammunition | Glamorization/Gratuitous depiction of illegal sale or |
| | possession of Arms |
| | Depictions of sale/use/distribution of illegal arms for |
| | inappropriate uses//harmful acts |
| Crime & Harmful acts to | Depictions of criminal/harmful acts or violation of |
| individuals and Society, | human rights |
| Human Right Violations | |
| Death, Injury or Military | Depiction of death or Injury |
| Conflict | Insensitive and irresponsible treatment of military |
| | conflict, genocide, war crimes, or harm resulting in |
| | Death or Injury |
| | Depictions of military actions that glamorize harmful |
| | acts to others or society |
| Online piracy | Glamorization/Gratuitous depiction of Online Piracy |
| Hate speech & acts of | Depiction or portrayal of hateful, denigrating, or inciting |
| aggression | content focused on race, ethnicity, gender, sexual |
| | orientation, gender identity, age, ability, nationality, |
| | religion, caste, victims and survivors of violent acts and |
| | their kin, immigration status or serious disease sufferers, |
| | in a non-educational, informational, or scientific context |
| Obscenity and Profanity, | Glamorization/Gratuitous depiction of profanity and |
| including language, gestures, | obscenity |
| and explicitly gory, graphic or | |
| repulsive content intended to | |
| shock and disgust | |
| Illegal Drugs/Tobacco/e- | Glamorization/Gratuitous depictions of illegal |
| cigarettes/Vaping/Alcohol | drugs/abuse of prescription drugs |
| | Insensitive and irresponsible content/treatment that |
| | encourages minors to use tobacco and vaping products |
| | & Alcohol |
| Spam or Harmful Content | Glamorization/Gratuitous depiction of Online Piracy |

In one embodiment, unacceptable global content standards 145 may include medium risk unacceptable content listed in Table 3 from the GARM document GARM: Brand Safety Floor. Suitability Framework.

TABLE 3

| Category | Unacceptable Content |
|---|---|
| Adult & Explicit Sexual | Dramatic depiction of sexual acts or Sexuality issues |
| Content | presented in the context of entertainment |
| | Artistic Nudity |
| Arms & Ammunition | Dramatic depiction of weapons use presented in the |
| | context of entertainment |
| | Breaking News or Op-Ed coverage of arms and |
| | ammunition |
| Crime & Harmful acts to | Dramatic depiction of criminal activity or human rights |
| individuals and Society, | violations presented in the context of entertainment |
| Human Right Violations | Breaking News or Op-Ed coverage of criminal activity or |
| | human rights violations |
| Death, Injury or Military | Dramatic depiction of death, injury, or military conflict |
| Conflict | presented in the context of entertainment |
| | Breaking News or Op-Ed coverage of death, injury or |
| | military conflict |
| Online piracy | Dramatic depiction of Online Piracy presented in the |
| | context of entertainment |
| | Breaking News or Op-Ed coverage of Online Piracy |
| Hate speech & acts of | Dramatic depiction of hate speech/acts presented in the |
| aggression | context of entertainment |
| | Breaking News or Op-Ed coverage of hate speech/acts |
| Obscenity and Profanity, | Dramatic depiction of profanity and obscenities |
| including language, gestures, | presented in the context of entertainment by genre |
| and explicitly gory, graphic or | Breaking News or Op-Ed coverage of profanity and |
| repulsive content intended to | obscenities Genre based use of profanity, gestures, and |
| shock and disgust | other actions that may be strong, but might be expected |
| | as generally accepted language and behavior |
| Illegal Drugs/Tobacco/e- | Dramatic depiction of illegal drug use/prescription |
| cigarettes/Vaping/Alcohol | abuse, tobacco, vaping or alcohol use presented in the |
| | context of entertainment |
| | Breaking News or Op-Ed coverage of illegal drug |
| | use/prescription abuse, tobacco, vaping or alcohol use |
| Spam or Harmful Content | Dramatic depiction of Spam or Malware presented in |
| | the context of entertainment |
| | Breaking News or Op-Ed coverage of Spam or Malware |

In one embodiment, unacceptable global content standards 145 may include low risk unacceptable content listed in Table 4 from the GARM document GARM: Brand Safety Floor. Suitability Framework.

TABLE 4

| Category | Unacceptable Content |
|---|---|
| Adult & Explicit Sexual | Educational, Informative, Scientific treatment of sexual |
| Content | subjects or sexual relationships or sexuality |
| Arms & Ammunition | Educational, Informative, Scientific treatment of Arms |
| | use, possession or illegal sale |
| | News feature stories on the subject |
| Crime & Harmful acts to | Educational, Informative, Scientific treatment of crime |
| individuals and Society, | or criminal acts or human rights violations |
| Human Right Violations | News feature stories on the subject |
| Death, Injury or Military | Educational, Informative, Scientific treatment of death |
| Conflict | or injury, or military conflict |
| | News feature stories on the subject |
| Online piracy | Educational, Informative, Scientific treatment of Online |
| | Piracy |
| | News feature stories on the subject |
| Hate speech & acts of | Educational, Informative, Scientific treatment of Hate |
| aggression | Speech |
| | News features on the subject |
| Obscenity and Profanity, | Educational or Informative, treatment of Obscenity or |
| including language, gestures, | Profanity |
| and explicitly gory, graphic or | News feature stories on the subject |
| repulsive content intended to | |
| shock and disgust | |
| Illegal Drugs/Tobacco/e- | Educational, Informative, Scientific treatment of illegal |
| cigarettes/Vaping/Alcohol | drug use/prescription abuse, tobacco, vaping or alcohol |
| | News feature stories on the subject |
| Spam or Harmful Content | Educational, Informative, Scientific treatment of Spam or |
| | Malware |
| | News feature stories on the subject |

In addition, the global content standards 145 may describe value neutral characteristics of content media 120. For example, value neutral global content standards 145 may include but are not limited to political content, promotional content, critical content, and the like. In a certain embodiment, the global content standards 145 may describe positive characteristics of the content media 120. For example, the positive global content standards 145 may include but are not limited to feel good content, motivational content, and the like.

In one embodiment, a global content standard 145 may comprise a combination of one or more of unacceptable global content standards 145, value neutral global content standards 145, and positive global content standards 145. In addition, the global content standards 145 may indicate whether content media 120 that includes the combination of global content standards 145 is a violation or not a violation of the combination of global content standards 145.

In one embodiment, a global content standard 145 may be specific to an advertiser. For example, the advertiser global content standard 145 may comprise a combination of one or more of unacceptable global content standards 145, value neutral global content standards 145, and positive global content standards 145 for the advertiser.

In one embodiment, the global content standards 145 are not less than a specified guideline and/or standard. In a certain embodiment, the global content standards 145 are not less than the advertiser global content standard 145 for a specified advertiser. In addition, the global content standards 145 may not be less than the advertiser global content standard 145 for any advertiser.

The advertising scores 201 may be based on impression measurements for the corresponding advertising campaigns 165. In one embodiment, the advertising scores 201 are based on the impression measurements for the corresponding advertising campaign 165 before and after presentation of the corresponding advertising campaign 165.

The global standards model 140 may be trained on the global content standards 145 and the advertising scores 201. In one embodiment, at least one global content model 140 is generated for each advertising campaign 165. In addition, at least one global content model 140 may be generated for each global content standard 145. In one embodiment, each global standards model 140 is trained on one or more selected global content standards 145.

Content media 120 correlated to low advertising scores 201 may be indicative of violating the global content standards 145. Alternatively, content media 120 correlated to low advertising scores 201 may bias the training of the global standards model 140 to indicate a violation of the global content standards 145.

Global standards models 140 are trained on the global content standards 145 and/or advertising scores 201 to review content media 120 and determine whether the content media 120 violates the global content standards 145. For example, if the global content standards 145 prohibit nudity and content media 120 includes nudity, the global standards model 140 may determine that the content media 120 violates the global content standards 145.

FIG. 2B is a schematic block diagram illustrating one embodiment of training campaign characteristic models 150. The campaign characteristics 155, advertising scores 201, and campaign characteristic models 150 may be organized as a data structure in a memory. The content manager 130 may employ the campaign characteristic models 150 to generate characteristic scores and/or category scores 160. In the depicted embodiment, the campaign characteristic models 150 are trained on the campaign characteristics 155 and/or the advertising scores 201.

Each campaign characteristic 155 may describe target characteristic of an advertising campaign 165. Campaign characteristics 155 may include but are not limited to age, age range, gender, marital status, income, geography, employment status, occupation, employer, avocations, purchases, and the like.

The advertising scores 201 may be correlated to the campaign characteristics 155. For example, a plurality of advertising scores 201 may be associated to each campaign characteristics 155.

The campaign characteristic models 150 are trained to review content media 120 and determine characteristic scores for the content media 120. For example, a campaign characteristic 155 may be married men. One or more campaign characteristic models 150 may be trained to recognize how appealing media content 120 is to married men expressed as a characteristic score.

FIG. 2C is a schematic block diagram illustrating one embodiment of generating block lists 125. In the depicted embodiment, content media 120 is reviewed by the global standards models 140. The content media 120 may be reviewed by at least one global standards model 140 for each advertising campaign 165. Each global standards model 140 may indicate whether the content media 120 violates the global content standards

In one embodiment, the global standards models 140 generate a violation score 190 that indicates the degree to which the content media 120 violates the global standards models 140. The violation score 190 may aggregate violations for each of the global standards models 140. Alternatively, the violation score 190 may be a vector value that indicates the degree of violation for each of the global standards models 140.

In one embodiment, if the media content 120 is indicated to violate at least one global content standard 145, the media content 120 is added to a block list 125 for the corresponding advertising campaign 165. Alternatively, the media content 120 may be added to the block list 125 for the corresponding advertising campaign 165 if the media content 120 is indicated to violate a threshold number of global content standards 145. In a certain embodiment, the global content standards 145 each comprise a standard weight. The content media 120 may be added to the block list 125 for the corresponding advertising campaign 165 if the content media 120 is indicated to violate global content standards 145 with standard weights that some to exceed a weight threshold.

In one embodiment, the content media 120 violates the global content standards 145 if the violation score 190 exceeds a violation threshold. The violation threshold may be a scaler value corresponding to aggregated violations for each of the global standards models 140. Alternatively, the violation threshold may be a vector value that indicates the maximum degree of acceptable violation for each of the global standards models 140.

In one embodiment, blocked content media 120 on a block list 125 is unblocked in response to the content media 120 not violating the global content standards 145 as determined by the global standards model 140. The content media 120 may be removed from the block list 125 to unblock the content media 120. The content media 120 may be unblocked based on an update to the global standards models 140. In addition, the content media 120 may be unblocked based on a change in a ranking of the violation score 190. In one embodiment, the content media 120 may be unblocked based on a change in the violation threshold.

FIG. 2D is a schematic block diagram illustrating one embodiment of generating category scores 160. The category combiner 170 may comprise data and code executed by the computer. The advertising categories 175 may be organized as a data structure in a memory. In the depicted embodiment, the campaign characteristic models 150 evaluate the content media 120. Each of the content media 120 may be evaluated by each of the campaign characteristic models 150. Each campaign characteristic model 150 may generate a characteristic score 185 for each of the content media 120. The characteristic score 185 may indicate the degree to which the content media 120 appeals and/or conforms to the campaign characteristics 155 and/or advertising scores 201 used to train the campaign characteristic model 150. The characteristic score 185 may be a binary value, an integer value, a real number value, a vector value, a text description, and the like.

A category combiner 170 combines the characteristic scores 185 into a plurality of category scores 160. The characteristic scores 185 may be combined based on the advertising categories 175. For example, a category score 160 may be for an advertising category 175 of young adults interested in travel. To generate the young adults interested in travel category score 160, the category combiner 170 may combine a young adult characteristic score 185 and a travel characteristic score 185. In a certain embodiment, weighted values of the young adult characteristic score 185 and the travel characteristic score 185 are summed to generate the category score 160.

In addition, the category combiner 170 may include negative characteristic scores 185 in determining category scores 160. For example, a too distant characteristic score 185 may be included in the young adults interested in travel category score 160 to reduce the category score 160 for extremely distant locations. In one embodiment, the category combiner subtracts weighted values of specified characteristic scores 185 to generate the category scores 160.

FIG. 2E is a schematic block diagram illustrating one embodiment of generating advertising scores 201. In the depicted embodiment, the advertising score 201 is generated based on at least one of the category scores 160, the impression measurements 180, and the advertiser preferences 135.

The impression measurements 180 may measure impressions and/or interactions by users at one or more locations. The locations may be digital addresses such as a website, a mobile app, telephone numbers, and the like. In addition, the locations may be physical locations such as a retail store, an entertainment venue, and the like. In one embodiment, the impression measurements 180 for a given advertising campaign 165 are based on impressions measured before presentation of the given advertising campaign 165 and impressions measured after presentation at the given advertising campaign 165.

The advertiser preferences 135 may also be used to generate the advertising score 201. The advertiser preferences 135 may include but are not limited to geographic preferences, demographic preferences, income preferences, occupation preferences, gender preferences, and the like.

The advertising score 201 may be a binary value, a scaler value, a vector value, a text value, and the like. The advertising score 201 may be generated as one or more weighted sums of the category scores 160, the impression measurements 180, and/or the advertiser preferences 135. In one embodiment, the advertising scores 201 are generated via algorithms including optimized algorithms based on advertiser preferences 135. The algorithms may use one or more of maximums, minimums, averaged scores, threshold scores, and machine learned models to generate the advertising scores 201.

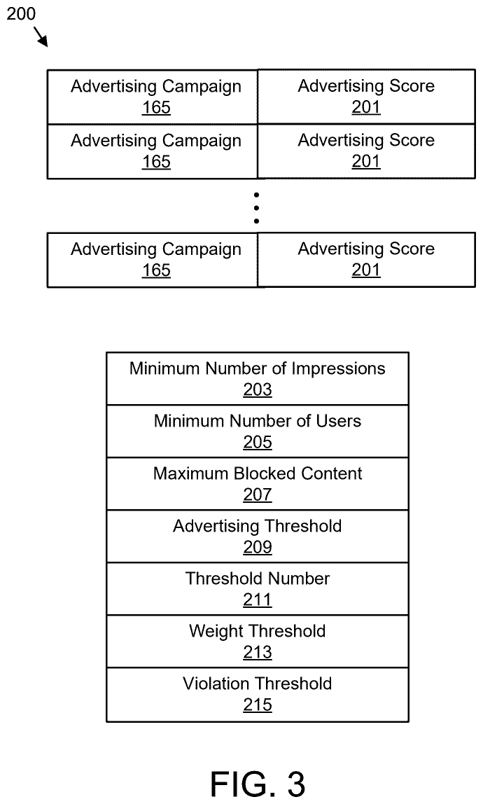

FIG. 3 is a schematic block diagram illustrating one embodiment of advertising data 200. The advertising data 200 may be organized as a data structure in a memory. In the depicted embodiment, the advertising data 200 includes a plurality of advertising campaigns 165 and corresponding advertising scores 201. Advertising campaigns 165/advertising scores 201 may be recorded for each content media 120. In addition, advertising campaigns 165/advertising scores 201 may be recorded for each impression of the content media 120.

The advertising data 200 may also include a minimum number of impressions 203, a minimum number of users 205, maximum blocked content 207, an advertising threshold 209, the threshold number 211, the weight threshold 213, and the violation threshold 215.

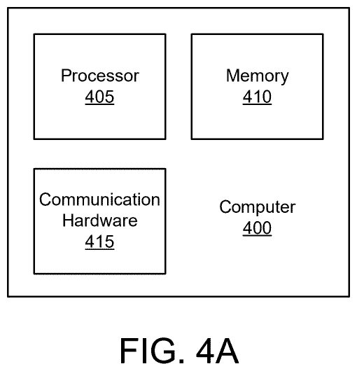

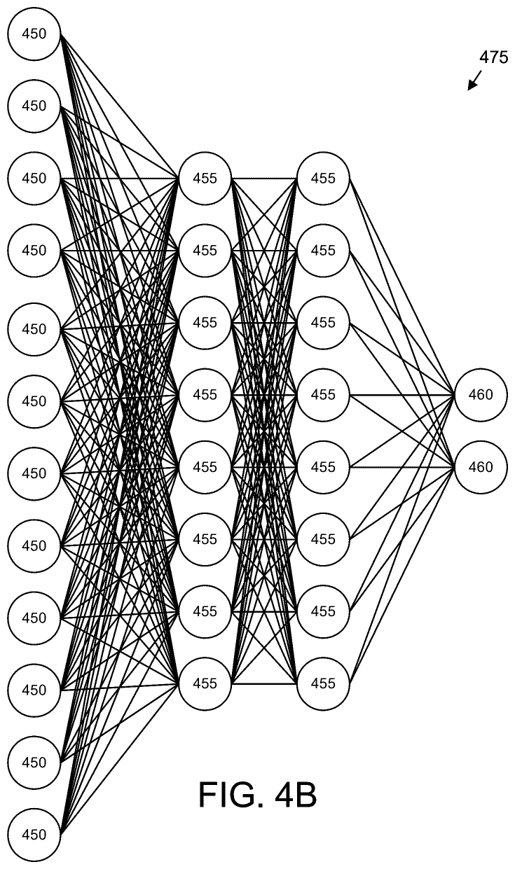

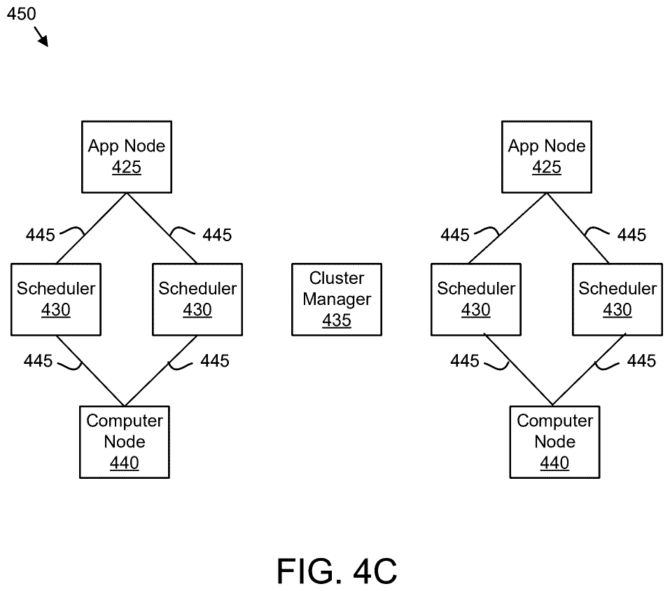

FIG. 4A is a schematic block diagram illustrating one embodiment of a computer 400. In the depicted embodiment, the computer 400 includes a processor 405, memory 410, and communication hardware 415. The memory 410 may store code and data. The processor 405 may execute the code and process the data. The communication hardware 415 may communicate with other devices.

FIG. 4B is a schematic block diagram illustrating one embodiment of a neural network 475. In the depicted embodiment, the neural network 475 includes input neurons 450, hidden neurons 455, and output neurons 460. The neural network 475 may be organized as a convolutional neural network, a recurrent neural network, long short term memory (LSTM) network, and the like.

The neural network 475 may be trained with training data. The training data may include the global content standards 145, the advertising scores 201, the campaign characteristics 155, and the like. The neural network 475 may be trained using one or more learning functions while applying the training data to the input neurons 450 and known result values for the output neurons 460. Subsequently, the neural network 475 may receive actual data at the input neurons 450 and make predictions at the output neurons 460 based on the actual data. The actual data may include a violation score 190 for a block list 125, characteristic scores 185, and the like.

FIG. 4C is a schematic block diagram illustrating one embodiment of a computer cluster 450. The architecture of the computer cluster 450 provides high bandwidth and high computational capabilities that exceed those of the computer 400. At least one computer cluster 450 may be required to practice the embodiments of the invention. In the depicted embodiment, the computer cluster 450 includes at least two application nodes 425, at least four schedulers 430, at least two computer nodes 440, and a cluster manager 435.

The application nodes 425 generates task requests 425 that embody the steps of the invention. The application nodes 425 communicate the task requests 445 to one of the schedulers 430. The scheduler 430 manages the completion of the task requests 445 so that task requests 445 are completed in parallel and/or out of order. The scheduler 430 identifies a computer node 440 that can efficient complete the task request 445 and assigns the task request 445 to the computer node 440. The computer nodes 440 respond with completed task requests 445. The schedulers 430 coordinate the assembly of the completed task requests 445 for the application nodes 425. The cluster manager coordinates the schedulers 430, application nodes 425, and computer nodes 440. The computer cluster 450 allows multiple steps of the invention to be performed concurrently, in parallel, and/or out of order, improving the efficiency and efficacy of performing the invention.

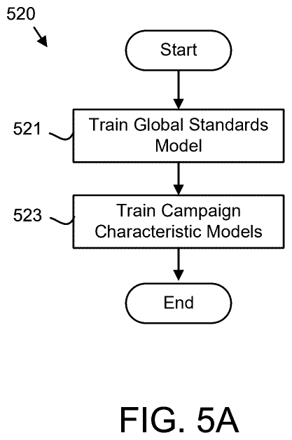

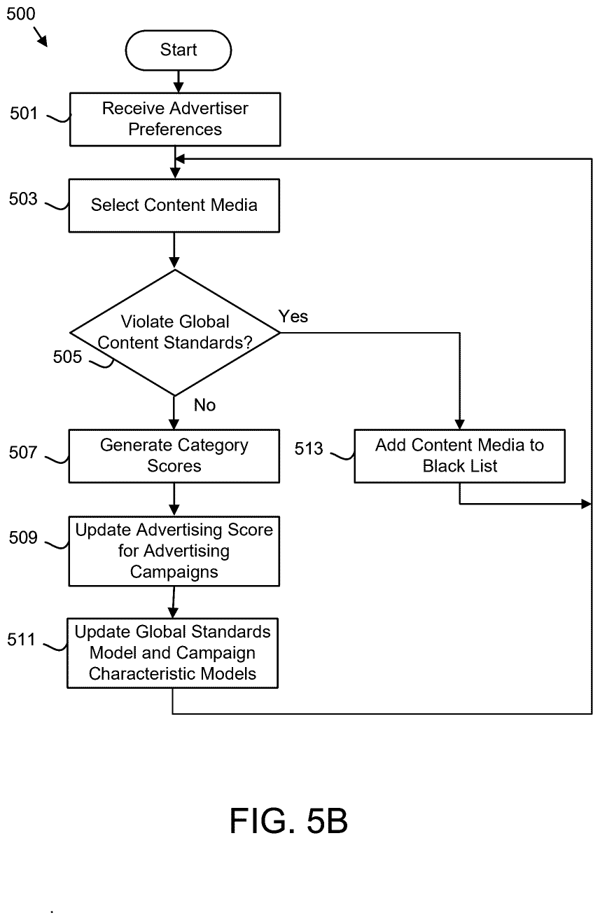

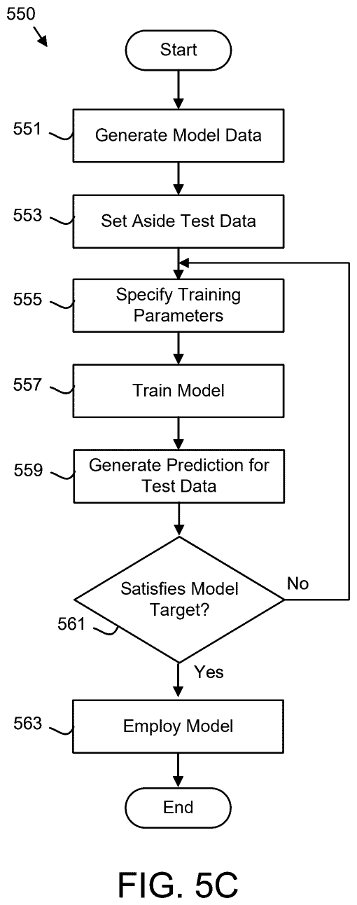

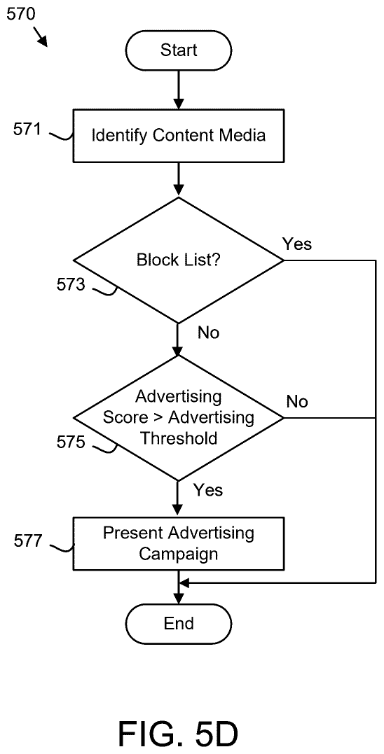

FIG. 5A is a flow chart diagram illustrating one embodiment of a method 520 of training models. The method 520 trains the global standards models 140 and the campaign characteristic models 150. The method 520 may be performed by the advertising system 100, a computer cluster 450, a computer 400, and/or a processor 405.

The method 520 may train 521 the global standards model 140 using the global content standards 145 and/or the advertising scores 201 as inputs. In one embodiment, the global standards model 140 may be trained to generate a violation/no violation indication for the global content standards 145 as outputs. In addition, the global standards model 140 may be trained to generate a violation score 190 as outputs.

The method 520 further trains 523 the campaign characteristic models 150 using the campaign characteristics 155 and/or advertising scores 201 as inputs. In one embodiment, the campaign characteristic models 150 may be trained to generate characteristic scores 185 as outputs.

FIG. 5B is a flow chart diagram illustrating one embodiment of a method 500 of generating category scores 201, updating advertising scores 201, and/or updating global standards models 140 and campaign characteristic models 150. The method 500 may be performed by the advertising system 100, a computer cluster 450, a computer 400, and/or a processor 405.

The method 500 receives 501 the advertiser preferences 135 for an advertising campaign 165. The advertising preferences 135 may be entered through a dashboard interface.

The method 500 selects 503 content media 120. The content media 120 may be selected in response to having the minimum number of impressions 203 for the content media 120. For example, if content media 120 has had 700 impressions such as views and the minimum number of impressions 203 is 500, the content media 120 is selected 503.

In one embodiment, the content media 120 is selected based on the minimum number of users 205. For example, if the content media 120 has been viewed by 60 users and the minimum number of users 205 is 50, the content media 120 is selected 503.

In one embodiment, the content media 120 is selected by a user via the electronic device 110. In addition, the content media 120 may be selected 503 by the content manager 130 in order to generate and/or update one or more of the category scores 160, the advertising score 201, the global standards model 140, the campaign characteristic model 150 and/or the block lists 125. In a certain embodiment, all content media 120 is periodically selected 503. Alternatively, content media 120 that is regularly requested by users via electronic devices 110 is selected 503. In one embodiment, content media 120 that is associated with an advertising campaign 165 is selected 503.

The method 500 determines 505 whether the content media 120 violates the global content standards 145 using the global standards model 140. In one embodiment, at least one block list 125 is checked for the content media 120. The content media 120 violates the global content standards 145 if the content media 120 is on the block list 125.

In one embodiment, the content media 120 is input to the global standards model 140 and the global standards model 140 indicates whether the content media 120 violates the global content standards 145. In one embodiment, the global standards model 140 generates the violation score 190 for the content media 120 and the content media 120 violates the global content standards 145 if the violation score 190 exceeds the violation threshold 215 as described in FIG. 2C.

If the content media 120 violates the global content standards 145, the content media 120 is added 513 to a block list 125. The block list 125 may correspond to a global content standard 145. In addition, the block list 125 may be associated with an advertising campaign 165.

In one embodiment, no more than the maximum blocked content 207 of content media 207 is added to the block list 125 to be blocked. For example, the maximum blocked content 207 may be 20,000. The violation scores 190 for all content media 120 may be ranked and only the highest-ranking content media 120 may be added to the block list 125 until the maximum blocked content 207 is reached.

If the content media 120 does not violate 505 the global content standards 145 and/or is not on a block list 125, the method 500 generates 507 category scores 160 using the campaign characteristic models 150. The category scores 160 may be generated 507 for each of the plurality of advertising categories 175. The campaign characteristic models 150 may review the content media 120 to generate the characteristic scores 185 and/or category scores 160 as described in FIG. 2D.

The method 500 may update 509 the advertising scores 201 for the content media 120 for each of the plurality of advertising campaigns 165. The advertising scores 201 may be updated 509 based on the category scores 160 and the advertiser preferences 135 for the plurality of advertising campaigns 165 as described in FIG. 2E.

In one embodiment, the method 500 updates the global standards model 140 and the campaign characteristic model 150 using the updated advertising scores 201. The global standards model 140 and the campaign characteristic model 150 may be updated 511 after a given number of impressions. In addition, the global standards model 140 and the campaign characteristic model 150 may be updated 511 after a specified time interval. The method 500 may loop to select 503 additional content media 120.

FIG. 5C is a flow chart diagram illustrating one embodiment of a method 550 of model training. The method 550 trains models such as the global standards models 140 or the campaign characteristic models 150. The method 550 may be performed by the advertising system 100, a computer 400, and/or a processor 405.

The method 550 generates 551 model training data such as the global content standards 145, the advertising scores 201, the campaign characteristics 155, and the like. The model training data may be historic data. In one embodiment, real-time model training data is also used. In a certain embodiment, training data from a specified time interval is used.

The method 550 may set aside 553 a portion of the model training data as test data. The test data will not be used to train the model.

The method 550 may specify 555 training parameters. The model is trained 557 using the model training data in accordance with the training parameters.

The method 550 generates 559 a prediction from the model with the test data. The prediction may be a violation score 190 or characteristic score 185. The method 550 determines 561 whether the prediction satisfies the target model. If the prediction does not satisfy the target model, the training parameters 275 are modified 555 and the model is again trained 557. If the prediction satisfies the target model, the trained model is employed 563 and the method 550 ends.

FIG. 5D is a flow chart diagram illustrating one embodiment of a method 570 of presenting an advertising campaign 165. The method 570 may present a given advertising campaign 165 with content media 120. The method 570 may be performed by the advertising system 100, a computer 400, and/or a processor 405.

The method 570 identifies 571 content media 120. The identified content media 120 may be selected by a user via an electronic device 110.

The method 570 determines 573 if the content media 120 is on a block list 125. In one embodiment, the method 570 determines 573 if the content media 120 is on the block list 125 for a specified advertising campaign 165. If the content media 120 is on the block list 125, the method 570 ends and the advertising campaign 165 is not presented for the content media 120.

If the content media 120 is not on the block list 125, the method 570 determines if the advertising score 201 for the content media 120 exceeds the advertising threshold 209. Each advertising campaign 165 may have a unique advertising threshold 209. If the advertising score 201 does not exceed the advertising threshold 209, the method 570 ends and the advertising campaign 165 is not presented for the content media 120.

If the advertising score 201 exceeds the advertising threshold 209, the method 570 presents 577 the advertising campaign 165 and the method 570 ends. The advertising campaign 165 is presented 577 based on the advertising score 201 and block list 125. The advertising campaign 165 may be presented 577 as video, audio, and/or text on the electronic device 110. In addition, the advertising campaign 165 may be presented as an email or text to the electronic device 110.

Advertising campaigns 165 can be costly if presented indiscriminately with content media 120. The embodiments described herein present advertising campaigns 165 for content media 120 based on the advertising score 201 and the block list 125. As a result, the advertising campaigns 165 are only presented for more commercially advantageous content media 120, increasing the efficiency and efficacy of the advertising campaigns 165.

This description uses examples to disclose the invention and also to enable any person skilled in the art to practice the invention, including making and using any devices or systems and performing any incorporated methods. The patentable scope of the invention is defined by the claims and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A method comprising:
training, using a computer cluster, a global standards model with global content standards and/or advertising scores, wherein the computer cluster comprises application nodes that communicate task requests to schedulers that manage the completion of the task requests in parallel and out of order on computer nodes that respond to the schedulers;
training, using the computer cluster, a plurality of campaign characteristic models on campaign characteristics and/or the advertising scores;
continuously scanning, using the computer cluster, content media;
identifying, using the computer cluster, whether the content media violates the global content standards using the global standards model;
in response to the content media violating the global content standards, adding, using the computer cluster, the identified content media to a block list and terminating processing of the content media;
in response to the content media not being on the block list, generating, using the computer cluster, category scores for a plurality of advertising categories using the campaign characteristic models;
updating, using the computer cluster, the advertising score for the content media for each of the plurality of advertising campaigns based on the category scores and advertiser preferences for the plurality of advertising campaigns; and
in response to a request for the content media via a network, communicating, using the computer cluster, a given advertising campaign with a given advertising score that exceeds an advertising threshold and is not on the block list with the content media via the network to an electronic device, minimizing traffic on the network.

2. The method of claim 1, wherein the advertising score is updated based on impression measurements for the given advertising campaign before and after presentation of the given advertising campaign.

3. The method of claim 2, the method further comprising updating the global standards model and the campaign characteristic models with the updated advertising scores.

4. The method of claim 1, wherein the given advertising campaign is presented in response to the advertising score exceeding an advertising threshold.

5. The method of claim 1, the method further comprising receiving the advertiser preferences for the plurality of advertising campaigns.

6. The method of claim 1, wherein the content media is selected based on a minimum number of impressions.

7. The method of claim 1, wherein the content media is selected based on a minimum number of users.

8. The method of claim 1, wherein no more than a maximum blocked content of content media is blocked.

9. The method of claim 1, wherein blocked content media is unblocked in response to the content media not violating the global content standards with the global standards model.

10. An apparatus comprising:
at least one computer cluster executing code to perform:
training a global standards model with global content standards and/or advertising scores, wherein the computer cluster comprises application nodes that communicate task requests to schedulers that manage the completion of the task requests in parallel and out of order on computer nodes that respond to the schedulers;
training a plurality of campaign characteristic models on campaign characteristics and/or the advertising scores;
continuously scanning content media;
identifying whether the content media violates the global content standards using the global standards model;
in response to the content media violating the global content standards, adding the identified content media to a block list and terminating processing of the content media;
in response to the content media not being on the block list, generating category scores for a plurality of advertising categories using the campaign characteristic models;
updating the advertising score for the content media for each of the plurality of advertising campaigns based on the category scores and advertiser preferences for the plurality of advertising campaigns; and
in response to a request for the content media via a network, communicating a given advertising campaign with a given advertising score that exceeds an advertising threshold and is not on the block list with the content media via the network to an electronic device, minimizing traffic on the network.

11. The apparatus of claim 10, wherein the advertising score is updated based on impression measurements for the given advertising campaign before and after presentation of the given advertising campaign.

12. The apparatus of claim 11, the processor further updating the global standards model and the campaign characteristic models with the updated advertising scores.

13. The apparatus of claim 10, wherein the given advertising campaign is presented in response to the advertising score exceeding an advertising threshold.

14. The apparatus of claim 10, the processor further receiving the advertiser preferences for the plurality of advertising campaigns.

15. The apparatus of claim 10, wherein the content media is selected based on a minimum number of impressions.

16. The apparatus of claim 15, wherein the content media is selected based on a minimum number of users.

17. The apparatus of claim 10, wherein no more than a maximum blocked content of content media is blocked.

18. The apparatus of claim 10, wherein blocked content media is unblocked in response to the content media not violating the global content standards with the global standards model.

19. A computer program product comprising a non-transitory storage medium storing code executable by a computer cluster to perform:
training a global standards model with global content standards and/or advertising scores, wherein the computer cluster comprises application nodes that communicate task requests to schedulers that manage the completion of the task requests in parallel and out of order on computer nodes that respond to the schedulers;
training a plurality of campaign characteristic models on campaign characteristics and/or the advertising scores;
continuously scanning content media;
identifying whether the content media violates the global content standards using the global standards model;
in response to the content media violating the global content standards, adding the identified content media to a block list and terminating processing of the content media;
in response to the content media not being on the block list, generating category scores for a plurality of advertising categories using the campaign characteristic models;
updating the advertising score for the content media for each of the plurality of advertising campaigns based on the category scores and advertiser preferences for the plurality of advertising campaigns; and
in response to a request for the content media via a network, communicating a given advertising campaign with a given advertising score that exceeds an advertising threshold and is not on the block list with the content media via the network to an electronic device, minimizing traffic on the network.

20. The computer program product of claim 19, wherein the advertising score is updated based on impression measurements for the given advertising campaign before and after presentation of the given advertising campaign.
